(19) United States
(12) Patent Application Publication
(10) Pub. No.: US 2020/0364656 A1
(43) Pub. Date: Nov. 19, 2020

(54) TASK DISPATCHING METHOD AND APPARATUS, ELECTRONIC DEVICE, AND COMPUTER-READABLE STORAGE MEDIUM

(71) Applicant: Beijing Xingxuan Technology Co., Ltd., Beijing (CN)

(72) Inventor: Fukun LIANG, Beijing (CN)

(21) Appl. No.: 16/986,530

(22) Filed: Aug. 6, 2020

Related U.S. Application Data
(63) Continuation of application No. PCT/CN2018/110278, filed on Oct. 15, 2018.

(30) Foreign Application Priority Data
Feb. 6, 2018 (CN) 201810118467.4

(51) Int. Cl. G06Q 10/08

(52) U.S. Cl. CPC G06Q 10/0834; G06Q 10/08355

(57) ABSTRACT

A task dispatching method may include: performing, for each of one or more delivery resources, a first match between a first delivery task and the delivery resource based at least on similarity between the first delivery task and a goods-unpicked delivery task group of the delivery resource; grouping the first delivery task and one or more unassigned delivery tasks into one or more unassigned delivery task groups in response to the first match failing for each of the delivery resources; and performing a second match between the unassigned delivery task groups and the delivery resources based on a preset match rule.

### CROSS REFERENCE TO RELATED APPLICATIONS

This patent application is a continuation application of International Application No. PCT/CN2018/110278, filed on Oct. 15, 2018, which claims priority to Chinese Patent Application No. 201810118467.4, filed on Feb. 6, 2018 and entitled “TASK DISPATCHING METHOD AND APPARATUS, ELECTRONIC DEVICE, AND COMPUTER-READABLE STORAGE MEDIUM.” Both of these applications are incorporated herein by reference in their entireties.

### TECHNICAL FIELD

The present disclosure relates to the field of computer technology, and in particular, to task dispatching methods, task dispatching apparatuses, electronic devices, and computer-readable storage mediums.

### BACKGROUND

With the development of Internet technology, more and more merchants or service providers provide services to users through Internet platforms. Many Internet services require couriers for delivery. Therefore, the rapidly increasing Internet services require high quality of dispatching couriers.

### SUMMARY

The embodiments of the present disclosure provide a task dispatching method, a task dispatching apparatus, an electronic device, and a computer-readable storage medium.

In the first aspect, an embodiment of the present disclosure provides a task dispatching method.

Specifically, the task dispatching method includes: performing, for each of one or more delivery resources, a first match between a first delivery task and the a delivery resource based at least on similarity between the first delivery task and a goods-unpicked delivery task group of the delivery resource; in response to the first match failing for each of the delivery resources, grouping the first delivery task and one or more unassigned delivery tasks into one or more unassigned delivery task groups; and performing a second match between the unassigned delivery task groups and the delivery resources based on a preset match rule.

In a second aspect, an embodiment of the present disclosure provides a task dispatching apparatus, including: a first matching module configured to perform, for each of one or more delivery resources, a first match between a first delivery task and the delivery resource based at least on similarity between the first delivery task and a goods-unpicked delivery task group of the delivery resource; a grouping module configured to, in response to the first match failing for each of the delivery resources, group the first delivery task and one or more unassigned delivery tasks into one or more unassigned delivery task groups; and a second matching module configured to perform a second match between the unassigned delivery task groups and the delivery resources based on a preset match rule.

In a third aspect, an embodiment of the present disclosure provides an electronic device including one or more processors and a memory for storing computer instructions that are executable by the one or more processors to perform operations comprising: performing, for each of one or more delivery resources, a first match between a first delivery task and the delivery resource based at least on similarity between the first delivery task and a goods-unpicked delivery task group of the delivery resource; in response to the first match failing for each of the delivery resources, grouping the first delivery task and one or more unassigned delivery tasks into one or more unassigned delivery task groups; and performing a second match between the unassigned delivery task groups and the delivery resources based on a preset match rule.

In a fourth aspect, an embodiment of the present disclosure provides a computer-readable storage medium having computer instructions stored thereon, wherein the computer instructions are executable by one or more processors to perform operations comprising: performing, for each of one or more delivery resources, a first match between a first delivery task and the delivery resource based at least on similarity between the first delivery task and a goods-unpicked delivery task group of the delivery resource; in response to the first match failing for each of the delivery resources, grouping the first delivery task and one or more unassigned delivery tasks into one or more unassigned delivery task groups; and performing a second match between the unassigned delivery task groups and the delivery resources based on a preset match rule.

In the embodiments of the present disclosure, when assigning a delivery task, the similarity between the delivery task and the unpicked task group of the delivery resource are considered so that the delivery task is matched with the delivery resource. If the matching fails, the delivery task and unassigned delivery tasks are divided into one or more groups, and then the one or more groups are matched with the delivery resource. According to the present disclosure, at the beginning of assigning the delivery task, it is determined whether to add a delivery task to a delivery resource based on the delivery task and the assigned-unpicked task group of the delivery resource. If the delivery task fails to add to the delivery resource, the delivery task and unassigned tasks are grouped to be assigned again to the delivery resource. Compared with the related art, there is no need to wait for the next scheduling period, the delivery task may be directly dispatched. There is no order delay link, and the delivery task may be performed first, which may reduce intermediate waiting links and ensure delivery in a timely manner, which is especially suitable for the delivery tasks that requires on-time delivery.

It may be understood that the above general descriptions and the below detailed descriptions are merely exemplary and explanatory, and are not intended to limit the present disclosure.

### BRIEF DESCRIPTION OF THE DRAWINGS

With reference to the accompanying drawings, through the following detailed description of the non-limiting embodiments, other features, objectives, and advantages of the present disclosure will become more apparent. In the accompanying drawings:

FIG. 1 shows a flowchart of a task dispatching method according to an embodiment of the present disclosure;

FIG. 2 shows a flowchart of forming unassigned delivery task group according to the method shown in FIG. 1;

FIG. 3 shows a flowchart of a dispatching delivery resource according to an embodiment of the present disclosure;

FIG. 4 shows a structural block diagram of a task dispatching apparatus according to an embodiment of the present disclosure;

FIG. 5 shows a structural block diagram of a grouping module according to the embodiment shown in FIG. 4;

FIG. 6 shows a structural block diagram of a dispatching delivery resource according to an embodiment of the present disclosure; and

FIG. 7 is a schematic structural diagram of an electronic device suitable for implementing a task dispatching method according to an embodiment of the present disclosure.

### DETAILED DESCRIPTION OF THE EMBODIMENTS

Hereinafter, exemplary embodiments of the present disclosure will be described in detail with reference to the accompanying drawings so that those skilled in the art may easily implement exemplary embodiments. In addition, for the sake of clarity, parts that are not related to describing the exemplary embodiments are omitted in the drawings.

In the present disclosure, it should be understood that terms such as “including” or “having” are intended to indicate the existence of the features, numbers, steps, actions, components, parts, or combinations thereof disclosed in this specification, but not intended to exclude the possible existence or addition of one or more other features, numbers, steps, actions, components, parts or combinations thereof.

In addition, it should be noted that the embodiments in the present disclosure and the features in the embodiments may be combined with each other if there is no conflict. Hereinafter, the present disclosure will be described in detail with reference to the drawings and in conjunction with embodiments.

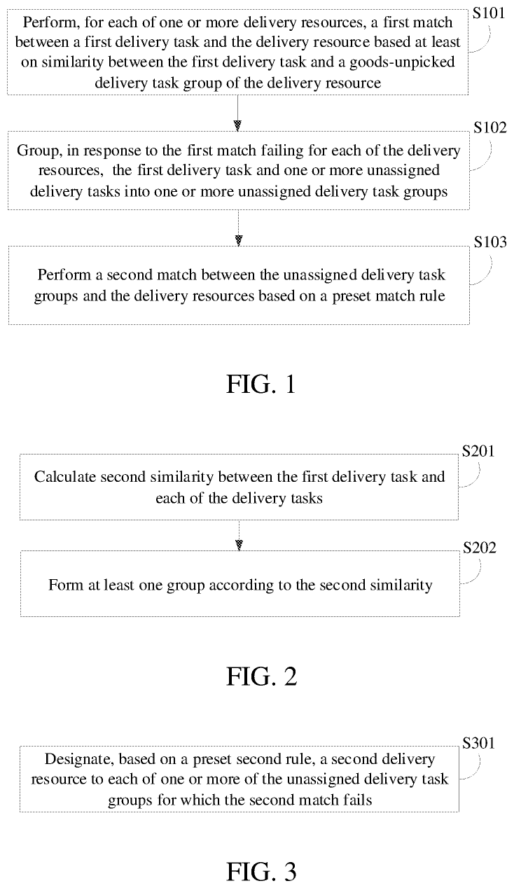

FIG. 1 shows a flowchart of a task dispatching method according to an embodiment of the present disclosure. As shown in FIG. 1, the task dispatching method includes the following steps S101-S103.

At step S101, for each of one or more delivery resources, a first match between a first delivery task and the delivery resource is performed based at least on similarity between the first delivery task and a goods-unpicked delivery task group of the delivery resource. Each delivery task of the goods-unpicked delivery task group has been assigned, but goods related thereto have not been picked up yet.

At step S102, in response to the first match failing for each of the delivery resources, the first delivery task and one or more unassigned delivery tasks are grouped into one or more unassigned delivery task groups.

At step S103, a second match between the unassigned delivery task groups and the delivery resources is performed based on a preset match rule.

In the related art, the life cycle of a delivery task starts with an order being placed, that is, generation of the delivery task, and ends with the delivery completion or cancellation, which forms a complete fulfillment chain.

The following briefly describes the fulfillment chain scenario.

Order placement: a user submits an instant order or an appointment order.

Order acceptance by a merchant: the order placed by the user has to be confirmed by the merchant, for example, through clicks on an order acceptor or a merchant terminal. It is also possible that, during this process, the merchant may cancel the order, such that the order cycle ends early.

Delivery resource assignment: after the merchant confirms the order, the system may assign a corresponding delivery resource after a certain order delay time. According to the order delay time, it may be determined whether the order may be added or merged with any other order.

Beginning of delivery: the delivery begins when the delivery resource has finished the last delivery task or has picked up the goods for the last delivery task, and is ready to pick up the goods for the delivery task.

Delivery resource arriving at store: a delivery resource arrives at the merchant's store to pick up goods. There may be a situation in which the delivery resource has to wait for the goods to be ready, or the goods are ready and have to wait for the delivery resource.

Delivery resource picking up goods: the delivery resource gets the goods and updates the corresponding delivery state through an application.

Arrival at delivery destination: after picking up the goods, the delivery resource may also pick up goods for another delivery task, and may perform the another delivery task or the like in the meantime. Finally, the delivery resource may deliver the goods to the destination according to a pickup-delivery sequence in a task mode.

Completion: when the delivery resource delivers goods to the user, the delivery task is completed.

In the related art, the delivery tasks may rely largely on the time when each merchant has prepared the goods. If a merchant delays in the meantime, subsequent delivery tasks may have to be delayed, thereby lowering the on-time delivery rate. For delivery tasks that has strict requirement on the delivery time, such as on-time delivery, the task delivery methods in the related art may not meet the such requirements.

In this embodiment of the present disclosure, for the delivery task, firstly, it is determined whether the delivery task may be added to a delivery resource by considering the first similarity between the delivery task and a goods-unpicked delivery task group that has been assigned to the delivery resource. Of course, it should be understood that when performing the first match between the first delivery task and the delivery resource, in addition to considering the similarity to the goods-unpicked delivery task group that has been assigned to the delivery resource, other factors may also be considered, such as whether the delivery time of the unpicked delivery task group may be affected, other personalized information of the delivery resource per se and the like, which may be set according to the actual situation and are not limited herein.

In normal circumstances, a plurality of delivery tasks with delivery addresses, pickup addresses, and goods ready timings all within certain threshold ranges are grouped, and then assigned in group to a delivery resource, which may allow the delivery resource to deliver the plurality of delivery tasks of one task group on the way. If a delivery task is similar to a task group assigned to the delivery resource, the delivery task may be added to the similar task group so that the delivery resource may deliver the delivery task, which may save the delivery time of the delivery task and ensure the delivery timeliness. Of course, as long as the addition of the delivery task will not substantially impact the on-time delivery of each delivery task in the assigned task group, that is, the delivery time will not exceed the promised delivery time.

If the delivery task cannot be added to any delivery resource since it cannot meet the above condition, the delivery task will be grouped with other unassigned delivery tasks, and then the grouped unassigned delivery task group is matched with the delivery resource based on a matching rule. The matching rule here is different from that used at step S101. At step S101, the delivery task is matched with the delivery resource, and at this step, the grouped unassigned delivery task group is matched with the delivery resource, and the delivery task is included in one of the unassigned delivery task groups. In the second match between the unassigned delivery task groups and the delivery sources, match methods in the related art may be used. For example, fitting scores between a plurality of unassigned delivery task groups and a plurality of delivery resources are calculated, and an optimal solution is determined through a KM algorithm, so that each of the unassigned delivery task groups corresponds to at least one optimal delivery resource. If the fitting score of the optimal delivery resource corresponding to the unassigned delivery task group is higher than a preset threshold, the unassigned delivery task group is assigned to the delivery resource. If the fitting score is lower than the preset threshold, the unassigned delivery task group is not assigned to the delivery resource, and will be assigned by other methods.

In the embodiment, when performing the first match between the first delivery task and the delivery resource, in a case where the first match fails for each of the delivery resources or in response to the first match failing for each of the delivery resources, the first delivery task and other unassigned delivery tasks are directly grouped into one or more unassigned delivery task groups, and then assigned the unassigned delivery task groups to delivery resources. There is no need to wait for the next scheduling period in the process. If the delivery task fails to be added to a delivery resource, a dispatching strategy will be used for assigning the first delivery task directly. There is no order delay time, and the delivery time will be greatly improved, which may ensure the on-time delivery of the delivery tasks, especially suitable for on-time delivery tasks that has strict requirement on timeliness.

In an optional implementation, the delivery task is an on-time delivery task to be delivered within a predetermined time; the delivery resource is a reserved delivery resource for delivering the on-time delivery task. In the system, when a user places an order, he may choose to use an on-time delivery service, that is, to ensure on-time delivery within a predetermined time. This kind of delivery task is referred to as on-time delivery task. Once the system receives an on-time delivery task, the system may use the task delivery method in the embodiment shown in FIG. 1 to assign a delivery resource to the on-time delivery task. In the optional implementation, in order to further ensure the delivery timeliness and be able to be delivered on time within a specified time, the delivery resource may be a part of the reserved delivery resource, which is specifically used to deliver the on-time delivery task.

In an optional implementation of this embodiment, as shown in FIG. 2, at step S102, that is, the step of dividing the delivery task and one or more unassigned delivery tasks into one or more unassigned delivery task groups, further includes steps S201-S202.

At step S201, second similarity between the first delivery task and each of the unassigned delivery tasks are calculated.

At step S202, at least one group is formed according to the second similarity.

In this optional implementation, after the first delivery task has failed to be added to an assigned-unpicked delivery task group of a delivery resource, the first delivery task is grouped by calculating the second similarity between the first delivery task and each of the unassigned delivery tasks. Delivery tasks with second similarity higher than a preset threshold are divided into one group, resulting in one or more groups. For an on-time delivery task (the first delivery task, for example), when the system receives the on-time delivery task, the system determines whether to add the on-time delivery task to an assigned-unpicked delivery task group of a delivery resource based on first similarity and other factors. Here, the unassigned delivery tasks include but not limited to the on-time delivery task that has failed to be added to the delivery resource. That is to say, this step is grouping the first delivery task and other on-time delivery tasks that has failed to be added to the delivery resource. This step is direct grouping the delivery task and other on-time delivery tasks after the delivery task has failed to be added to the delivery resource, instead of making the delivery task to wait for a next adding task scheduling period or a next unassigned task scheduling period. For a normal delivery task that requires less timeliness, after the normal delivery task is received, the normal delivery task may be made wait for the next unassigned task scheduling period for scheduling or dispatching. If the scheduling fails, the normal delivery task may be made wait for another scheduling period. There may be a long order delay time, and for the on-time delivery task, since there is no need to wait for the next scheduling period, order delay time may not exist, and the timeliness is high.

In an optional implementation of this embodiment, after step S101, that is, the step of performing the first match between the first delivery task and the delivery resource, the method further includes the following steps:

In response to the first match being successful for one of the delivery resources, the first delivery task is assigned to one delivery resource.

In this optional implementation, if the delivery task and the delivery resource are successfully matched, that is, the delivery task has a high degree of similarity with an assigned-unpicked delivery task group of a delivery resource, and other conditions are satisfied, the delivery task is added to the unpicked delivery task group of the delivery resource, and the delivery task is delivered by the delivery resource. Thus, it may improve the delivery timeliness of the delivery task and effectively ensure on-time delivery.

In an optional implementation of this embodiment, as shown in FIG. 3, after step S103, that is, the performing of a second match, the method further includes step S301.

At step S301, based on a preset second rule, a second delivery resource is designated to each of one or more of the unassigned delivery task groups for which the second match fails.

In this optional implementation, if the first match between the unassigned delivery task group and the delivery resource fails, that is, the fitting score calculated by the fitting score algorithm described above is lower than the preset threshold, in order to ensure the on-time delivery timeliness of the delivery tasks, the unassigned delivery task group that fails in the first match is assigned to an appropriate delivery resource. The selection of appropriate delivery resource may be based on some pre-set rules, such as selecting a delivery resource with fewer assigned delivery tasks and less delivery pressure, even selecting a new delivery resource from a delivery resource pool for delivering normal delivery tasks to deliver the unassigned delivery task group. In this way, it may be guaranteed that the delivery task is assigned to the delivery resource in time, and it may be guaranteed that the delivery resource completes the delivery task before the expected delivery time arrives.

In an optional implementation of this embodiment, the method further includes the following steps:

if a relation between the reserved delivery resources and one or more unassigned on-time delivery tasks satisfies a first preset condition, acceptance of any on-time delivery tasks request is suspended; or,

if the relation between the reserved delivery resources and the one or more unassigned on-time delivery tasks satisfies a second preset condition, acceptance of an on-time delivery task requests is resumed.

In this optional implementation, the task dispatching method of this embodiment may be a dispatching scheduling method specifically for delivery tasks with high timeliness requirements, such as an on-time delivery task. Then, when the delivery pressure of the delivery resources is very high, it is very likely that not all on-time delivery tasks can be completed within an expected time. In this case, the system may turn off the option of submitting the on-time delivery task request, so that the user may no longer submit a request for an on-time delivery task. This is mainly due to the fact that, in normal circumstances, the request for the on-time delivery task needs to meet certain conditions, such as the user needs to pay additional fees for the on-time delivery task, and once the on-time delivery task request is accepted, if the on-time delivery task is not completed within the specified time, a certain fee has to be paid to the user for compensation. Based on cost considerations, when the delivery pressure exceeds an acceptable range, accepting on-time delivery task requests may be suspended, so as to dynamically adjust the supply and demand of the delivery services. Of course, it should be understandable that the supply and demand of the delivery services may also be dynamically adjusted by adjusting the cost for the user to request the on-time delivery task. In this optional implementation, the first preset condition may be a condition based on a ratio of a number of unassigned on-time delivery tasks to a number of reserved delivery resources. For example, the system scores the number of unassigned on-time delivery tasks and the number of reserved delivery resources in real time. If the ratio of the unassigned on-time delivery tasks to the reserved delivery resources exceeds a certain threshold, it is considered that the on-time delivery rate of the delivery resources cannot be guaranteed, and the option of submitting on-time delivery task requests may be temporarily disabled. Similarly, on the other side, the second preset condition may also be a condition based on the ratio of the number of unassigned on-time delivery tasks to the number of reserved delivery resources. If the ratio of the number of unassigned on-time delivery tasks to the number of reserved delivery resources is less than a certain threshold, the on-time delivery rate of the delivery resources may be guaranteed, the option of submitting on-time delivery task requests may be enabled again.

In an optional implementation of this embodiment, the method further includes the following step:

if the reserved delivery resources and the delivery task completion situation within a preset address range satisfy a third preset condition, an on-time delivery task preparation object within the preset address range that satisfies a fourth preset condition is determined. The on-time delivery task preparation object is an object that is capable of receiving an on-time delivery task and preparing goods for the on-time delivery task. For example, the preparation object may be a merchant or a service provider.

In this optional implementation, for on-time delivery tasks, in order to ensure timeliness, it is possible to choose to provide on-time delivery tasks only in a preset address range, and reserve a part of delivery resources in the preset address range dedicated to deliver the on-time delivery tasks. The preset address range may be determined based on whether the reserved delivery resources and delivery tasks completion situation within the preset address range satisfies the third preset condition. For example, for a take-out ordering service, the address range for providing on-time delivery tasks may be determined based on business district as a basic unit. The business districts satisfying the on-time delivery rate may be determined based on performance data over a period of time, such as the number of delivery men, delivery efficiency, the average meal preparing time of the entire business district, the average delivery time of the worst 10% orders less than M minutes and other rules. The third preset condition may be that there are a certain number of delivery men in the business district, and having little impact on other non-on-time (normal) delivery tasks in the business district, and the overall delivery efficiency in the previous period of time is relatively good, and in this case, the business district may be determined as the address range for providing on-time delivery tasks.

After the preset address range is determined, a preparation object who provides goods for an on-time delivery service may be selected within the preset address range. That is, a preparation object may be selected if the fourth preset condition is satisfied. The preparation object participates in the process of the delivery task in two aspects: a first aspect is a process from the time a user submits a delivery task request to the confirmation time of the preparation object, the confirmation time is usually very short and has little effect on the pickup of the deliver resource; a second aspect is a process for the preparation object to prepare goods, which may affect subsequent pickup of the delivery resource. For example, for a take-out ordering service, a merchant having an average meal preparing time less than N minutes may be selected as the preparation object for the on-time delivery task.

In an optional implementation of this embodiment, the determining of the on-time delivery task preparation object further includes the following step:

if goods preparing time of a preparation object within the preset address range is less than or equal to a preset threshold, the preparation object is determined as the on-time delivery task preparation object.

In the optional implementation, the on-time delivery task preparation object may be determined based on the goods preparing time of the preparation object. For example, if the average goods preparing time of the preparation object in a period of time of the past is less than or equal to the preset threshold, it may be considered that the preparation object may provide on-time delivery services and will not affect the entire delivery time or will not make it impossible to achieve the on-time delivery rate.

The followings are apparatus embodiments of the present disclosure, which may be used to implement the method embodiments of the present disclosure.

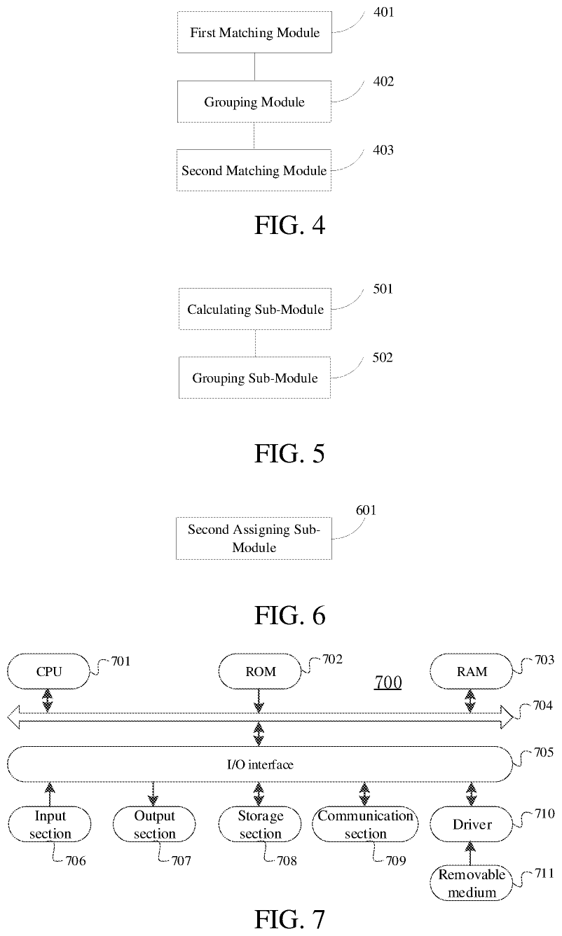

FIG. 4 shows a structural block diagram of a task dispatching apparatus according to an embodiment of the present disclosure. The apparatus may be implemented as part or all of an electronic device through software, hardware or a combination of both. As shown in FIG. 4, the task dispatching apparatus includes a first matching module 401, a grouping module 402, and a second matching module 403.

The first matching module 401 is configured to perform, for each of one or more delivery resources, a first match between a first delivery task and the delivery resource based at least on similarity between the first delivery task and a goods-unpicked delivery task group of the delivery resource.

The grouping module 402 is configured to, in response to the first match failing for each of the delivery resources, group the first delivery task and one or more unassigned delivery tasks into one or more unassigned delivery task groups.

The second matching module 403 is configured to perform a second match between the unassigned delivery task groups and the delivery resources based on a preset match rule.

In this embodiment, for the delivery task, firstly, it is determined whether the delivery task may be added to a delivery resource by considering the first similarity between the delivery task and a goods-unpicked delivery task group that has been assigned to the delivery resource. Of course, it should be understood that when performing the first match between the first delivery task and the delivery resource, in addition to considering the similarity to the goods-unpicked delivery task group that has been assigned to the delivery resource, other factors may also be considered, such as whether the delivery time of the unpicked delivery task group may be affected, other personalized information of the delivery resource per se and the like, which may be set according to the actual situation and are not limited herein.

In normal circumstances, a plurality of delivery tasks with delivery addresses, pickup addresses, and goods ready timings all within certain threshold ranges are grouped, and then assigned in group to a delivery resource, which may allow the delivery resource to deliver the plurality of delivery tasks of one task group on the way. If a delivery task is similar to a task group assigned to the delivery resource, the delivery task may be added to the similar task group so that the delivery resource may deliver the delivery task. This may save the delivery time of the delivery task and ensure the delivery timeliness, of course, as long as the addition of the delivery task will not substantially impact the timeliness of each delivery task in the assigned task group, that is, the delivery time will not exceed the promised delivery time.

If the delivery task cannot be added to any delivery resource since it cannot meet the above condition, the delivery task will be grouped with other unassigned delivery tasks, and then the grouped unassigned delivery task groups is matched with the delivery resource based on a matching rule. The matching rule here is different from that used in the first matching module 401. The first matching module 401 is configured to match the delivery task with the delivery resource, and the matching rule here is that the grouped unassigned delivery task groups is matched with the delivery resource, and the delivery task is included in one of the unassigned delivery task groups. In the second match between the unassigned delivery task groups and the delivery sources, match methods in the related art may be used. For example, fitting scores between a plurality of unassigned delivery task groups and a plurality of delivery resources are calculated, and an optimal solution is determined through a KM algorithm, so that each of the unassigned delivery task groups corresponds to at least one optimal delivery resource. If the fitting score of the optimal delivery resource corresponding to the unassigned delivery task group is higher than a preset threshold, the unassigned delivery task group is assigned to the delivery resource. If the fitting score is lower than the preset threshold, the unassigned delivery task group is not assigned to the delivery resource, and will be assigned by other methods.

In the embodiment, when performing the first match between the first delivery task and the delivery resource, in response to the first match failing for each of the delivery resources, the first delivery task and other unassigned delivery tasks are directly grouped into one or more unassigned delivery task groups, and then assigned the unassigned delivery task groups to delivery resources. There is no need to wait for the next scheduling period in the process. If the delivery task fails to be added to a delivery resource, a dispatching strategy will be used for assigning the first delivery task directly. There is no order delay time, and the delivery time will be greatly improved, which may ensure the on-time delivery of the delivery tasks, especially suitable for on-time delivery tasks that require highly on timeliness.

In an optional implementation, the delivery task is an on-time delivery task to be delivered within a predetermined time; the delivery resource is a reserved delivery resource for delivering the on-time delivery task. In the system, when a user places an order, he may choose to use an on-time delivery service, that is, to ensure on-time delivery within a predetermined time. This kind of delivery task is called on-time delivery task. Once the system receives an on-time delivery task, the system may use the task delivery method in the embodiment shown in FIG. 1 to assign a delivery resource to the on-time delivery task. In the optional implementation, in order to further ensure the delivery timeliness and be able to be delivered on time within a specified time, the delivery resource may be a part of the reserved delivery resource, which is specifically used to deliver the on-time delivery task

In an optional implementation of this embodiment, as shown in FIG. 5, the grouping module 402 includes a calculating sub-module 501 and a grouping sub-module 502.

The calculating sub-module 501 is configured to calculate second similarity between the first delivery task and each of the unassigned delivery tasks.

The grouping sub-module 502 is configured to form at least one group according to the second similarity.

In this optional implementation, after the first delivery task fails to be added to an assigned-unpicked delivery task group of a delivery resource, the first delivery task is grouped by calculating the second similarity between the first delivery task and each of the unassigned delivery tasks. Delivery tasks with second similarity higher than a preset threshold are divided into one group, resulting in one or more groups. For an on-time delivery task (the first delivery task), when the system receives the on-time delivery task, the system determines whether to add the on-time delivery task to an assigned-unpicked delivery task group of a delivery resource based on first similarity and other factors. Here, the unassigned delivery tasks include but not limited to the on-time delivery task that fails in adding to the delivery resource. That is to say, this step is grouping the first delivery task and other on-time delivery tasks that fail in adding to the delivery resource. This step is direct grouping the delivery task and other on-time delivery tasks after the delivery task failed to be added to the delivery resource, instead of making the delivery task to wait for a next adding task scheduling period or a next unassigned task scheduling period. At present, for a normal delivery task that requires less timeliness, after the normal delivery task is received, the normal delivery task may be made wait for the next unassigned task scheduling period for scheduling or dispatching. If the scheduling fails, the normal delivery task may be made wait for another scheduling period. There may be a long order delay time, and for the on-time delivery task, since there is no need to wait for the next scheduling period, order delay time may not exist, and the timeliness is high.

In an optional implementation of this embodiment, the first matching module 401 further includes a first assigning sub-module.

The first assigning sub-module is configured to, in response to the first match being successful for one of the delivery resources, assign the first delivery task to one delivery resource.

In this optional implementation, if the delivery task and the delivery resource are successfully matched, that is, the delivery task has a high degree of similarity with an assigned-unpicked delivery task group of a delivery resource, and other conditions are satisfied, the delivery task is added to the unpicked delivery task group of the delivery resource, and the delivery task is delivered by the delivery resource. Thus, it may improve the delivery timeliness of the delivery task and effectively ensure on-time delivery.

In an optional implementation of this embodiment, as shown in FIG. 6, the second matching module 403 includes a second assigning sub-module 601.

The second assigning sub-module 601 is configured to, based on a preset second rule, designate a second delivery resource to each of one or more of the unassigned delivery task groups for which the second match fails.

In this optional implementation, if the first match between the unassigned delivery task group and the delivery resource fails, that is, the fitting score calculated by the fitting score algorithm described above is lower than the preset threshold, in order to ensure the on-time delivery timeliness of the delivery tasks, the unassigned delivery task group that fails in the first match is assigned to an appropriate delivery resource. The selection of appropriate delivery resource may be based on some pre-set rules, such as selecting a delivery resource with fewer assigned delivery tasks and less delivery pressure, even selecting a new delivery resource from a delivery resource pool for delivering normal delivery tasks to deliver the unassigned delivery task group. In this way, it may be guaranteed that the delivery task is assigned to the delivery resource in time, and it may be guaranteed that the delivery resource completes the delivery task before the expected delivery time arrives.

In an optional implementation of this embodiment, the apparatus further includes a suspension module and a resuming module.

The suspension module is configured to, if a relation between the reserved delivery resources and one or more unassigned on-time delivery tasks satisfies a first preset condition, suspend acceptance of any on-time delivery tasks request.

The resuming module is configured to, if the relation between the reserved delivery resources and the one or more unassigned on-time delivery tasks satisfies a second preset condition, resume acceptance of an on-time delivery task requests.

In this optional implementation, the task dispatching method of this embodiment may be a dispatching scheduling method specifically for delivery tasks with high timeliness requirements, such as an on-time delivery task. Then, when the delivery pressure of the delivery resources is very high, it is very likely that not all on-time delivery tasks can be completed within an expected time. In this case, the system may turn off the option of submitting the on-time delivery task request, so that the user may no longer submit a request for an on-time delivery task. This is mainly due to the fact that, in normal circumstances, the request for the on-time delivery task needs to meet certain conditions, such as the user needs to pay additional fees for the on-time delivery task, and once the on-time delivery task request is accepted, if the on-time delivery task is not completed within the specified time, a certain fee has to be paid to the user for compensation. Based on cost considerations, when the delivery pressure exceeds an acceptable range, accepting on-time delivery task requests may be suspended, so as to dynamically adjust the supply and demand of the delivery services. Of course, it should be understandable that the supply and demand of the delivery services may also be dynamically adjusted by adjusting the cost for the user to request the on-time delivery task. In this optional implementation, the first preset condition may be a condition based on a ratio of a number of unassigned on-time delivery tasks to a number of reserved delivery resources. For example, the system scores the number of unassigned on-time delivery tasks and the number of reserved delivery resources in real time. If the ratio of the unassigned on-time delivery tasks to the reserved delivery resources exceeds a certain threshold, it is considered that the on-time delivery rate of the delivery resources cannot be guaranteed, and the option of submitting on-time delivery task requests may be temporarily disabled. Similarly, on the other side, the second preset condition may also be a condition based on the ratio of the number of unassigned on-time delivery tasks to the number of reserved delivery resources. If the ratio of the number of unassigned on-time delivery tasks to the number of reserved delivery resources is less than a certain threshold, the on-time delivery rate of the delivery resources may be guaranteed, the option of submitting on-time delivery task requests may be enabled again.

In an optional implementation of this embodiment, the apparatus further includes a determining module.

The determining module is configured to, if the reserved delivery resources and the delivery task completion situation within a preset address range satisfy a third preset condition, determine an on-time delivery task preparation object within the preset address range that satisfies a fourth preset condition, where the on-time delivery task preparation object is an object that is capable of receiving an on-time delivery task and preparing goods for the on-time delivery task.

In this optional implementation, for on-time delivery tasks, in order to ensure timeliness, it is possible to choose to provide on-time delivery tasks only in a preset address range, and reserve a part of delivery resources in the preset address range dedicated to deliver the on-time delivery tasks. The preset address range may be determined based on whether the reserved delivery resources and delivery tasks completion situation within the preset address range satisfies the third preset condition. For example, for a take-out ordering service, the address range for providing on-time delivery tasks may be determined based on business district as a basic unit. Which business districts may satisfy the on-time delivery rate may be determined based on performance data over a period of time, such as the number of delivery men, delivery efficiency, the average meal preparing time of the entire business district, the average delivery time of the worst 10% orders less than M minutes and other rules. The third preset condition may be that there are a certain number of delivery men in the business district, and having little impact on other non-on-time (normal) delivery tasks in the business district, and the overall delivery efficiency in the previous period of time is relatively good, and in this case, the business district may be determined as the address range for providing on-time delivery tasks.

After the preset address range is determined, a preparation object may be selected within the preset address range that may provide an on-time delivery service, that is, a preparation object that satisfies the fourth preset condition. The preparation object participates in the process of the delivery task in two aspects: a first aspect is a process from the time a user submits a delivery task request to the confirmation time of the preparation object, the confirmation time is usually very short and has little effect on the pickup of the deliver resource; a second aspect is a process time for the preparation object to prepare goods, which may affect subsequent pickup of the delivery resource. For example, for a take-out ordering service, a merchant having an average meal preparing time less than N minutes may be selected as the preparation object for the on-time delivery task.

In an optional implementation of this embodiment, the determining module includes a second determining sub-module.

The second determining sub-module is configured to, if goods preparing time of a preparation object within the preset address range is less than or equal to a preset threshold, determine the preparation object as the on-time delivery task preparation object.

In the optional implementation, the on-time delivery task preparation object may be determined based on the goods preparing time of the preparation object. For example, if the average goods preparing time of the preparation object in a period of time of the past is less than or equal to the preset threshold, it may be considered that the preparation object may provide on-time delivery services and will not affect the entire delivery time or make it impossible to achieve the on-time delivery rate.

Functions may be implemented by hardware, or by hardware executing corresponding software. The hardware or software includes one or more modules corresponding to the above-mentioned functions.

In a possible design, the structure of the task dispatching apparatus includes a memory and one or more processors, and the memory is configured to store one or more computer instructions that support the apparatus to execute the task dispatching methods, and the one or more processors are configured to execute computer instructions stored in the memory. The task dispatching apparatus may also include a communication interface for communicating with other devices or a communication network.

FIG. 7 is a schematic structural diagram of an electronic device suitable for implementing a task dispatching method according to an embodiment of the present disclosure.

As shown in FIG. 7, the electronic device 700 includes a central processing unit (CPU) 701, which may perform various processes in the above-mentioned embodiment shown in FIG. 1 according to a program stored in a read-only memory (ROM) 702 or a program loaded from a storage section 708 to a random access memory (RAM) 703. In the RAM 703, various programs and data required for the operation of the electronic device 700 are also stored. The CPU 701, the ROM 702, and the RAM 703 are connected to each other through a bus 704. An input/output (I/O) interface 705 is also connected to the bus 704.

The following components are connected to the I/O interface 705: an input section 706 including a keyboard, a mouse; an output section 707 including a cathode ray tube (CRT), a liquid crystal display (LCD) and a speaker; a storage section 708 including a hard disk; and a communication section 709 including a network interface card such as a LAN card, a modem. The communication section 709 performs communication processing via a network such as the Internet. A driver 710 is also connected to the I/O interface 705 as needed. A removable medium 711, such as a magnetic disk, an optical disk, a magneto-optical disk, a semiconductor memory, is installed on the driver 710 as needed, so that the computer program read therefrom is installed into the storage section 708 as needed.

In particular, according to an embodiment of the present disclosure, the method described above with reference to FIG. 1 may be implemented as a computer software program. For example, the embodiments of the present disclosure include a computer program product, which includes a computer program tangibly contained on a readable medium thereof, and the computer program includes program code for executing the method of FIG. 1. In such an embodiment, the computer program may be downloaded and installed from the network through the communication section 709, and/or installed from the removable medium 711.

The flowcharts and block diagrams in the drawings illustrate possible implementation architecture, a function, and an operation of a system, a method, and a computer program product according to various embodiments of the present disclosure. In this regard, each block in the route diagram or block diagram may represent a module, a program segment, or a part of the code, and the module, the program segment, or the part of the code contains one or more executable instructions for realizing the specified logical functions. It should also be noted that, in some optional implementations, the functions marked in the block may also occur in a different order from the order marked in the drawings. For example, two blocks shown in succession may actually be executed substantially in parallel, or may sometimes be executed in the reverse order, depending on the functions involved. It should also be noted that each block in the block diagram and/or flowchart, and the combination of the blocks in the block diagram and/or flowchart, may be implemented by a dedicated hardware-based system that performs the specified functions or operations, or it may be implemented by a combination of dedicated hardware and computer instructions.

The units or modules involved in the described embodiments of the present disclosure may be implemented in software or hardware. The described units or modules may also be provided in the processor, and the names of these units or modules do not constitute a limitation on the units or modules themselves under certain circumstances.

As another aspect, the present disclosure also provides a computer-readable storage medium. The computer-readable storage medium may be the computer-readable storage medium included in the apparatus in the above-mentioned embodiment; or it may be a computer-readable storage medium that exists separately, not built into the apparatus. The computer-readable storage medium stores one or more programs, and the programs are used by one or more processors to execute the methods described in the present disclosure.

The above description is only some embodiments of the present disclosure and an explanation of the applied technical principles. Those skilled in the art should understand that the scope of the present disclosure is not limited to some embodiments formed by certain combination of the above technical features, and may also cover other embodiments formed by any other combination of the above technical features and equivalent thereof without departing from the inventive concept, for example, embodiments formed by exchanging the above-mentioned features and the technical features disclosed in the present disclosure (but not limited to those) with similar functions.

1. A task dispatching method, comprising:
performing, for each of one or more delivery resources, a first match between a first delivery task and the delivery resource based at least on similarity between the first delivery task and a goods-unpicked delivery task group of the delivery resource;
in response to the first match failing for each of the delivery resources, grouping the first delivery task and one or more unassigned delivery tasks into one or more unassigned delivery task groups; and
performing a second match between the unassigned delivery task groups and the delivery resources based on a preset match rule.

2. The task dispatching method according to claim 1, wherein the first delivery task belongs to one or more on-time delivery tasks each of which needs to be completed within a predetermined time, and the delivery resources belong to reserved delivery resources for the on-time delivery tasks.

3. The task dispatching method according to claim 1, wherein the grouping the first delivery task and the unassigned delivery tasks into the unassigned delivery task groups comprises:
calculating second similarity between the first delivery task and each of the unassigned delivery tasks; and
forming at least one group according to the second similarity.

4. The task dispatching method according to claim 1, further comprising:
in response to the first match being successful for one of the delivery resources, assigning the first delivery task to the one delivery resource.

5. The task dispatching method according to claim 1, further comprising:
designating, based on a preset second rule, a second delivery resource to each of one or more of the unassigned delivery task groups for which the second match fails.

6. The task dispatching method according to claim 2, further comprising at least one of:
in response to determining that a relation between the reserved delivery resources and one or more unassigned on-time delivery tasks satisfies a first preset condition, suspending acceptance of any on-time delivery task request; or
in response to determining that the relation between the reserved delivery resources and the unassigned on-time delivery tasks satisfies a second preset condition, resuming acceptance of an on-time delivery task request.

7. The task dispatching method according to claim 2, further comprising:
in response to determining that the reserved delivery resources and delivery task completion situation within a preset address range satisfy a third preset condition, determining an on-time delivery task preparation object within the preset address range that satisfies a fourth preset condition, wherein the on-time delivery task preparation object is an object that is capable of receiving an on-time delivery task and preparing goods for the on-time delivery task.

8. The task dispatching method according to claim 7, wherein the determining of the on-time delivery task preparation object comprises:
in response to determining that goods preparing time of a preparation object within the preset address range is less than or equal to a preset threshold, determining the preparation object as the on-time delivery task preparation object.

9. An electronic device, comprising:
one or more processors; and
a memory for storing computer instructions that are executable by the one or more processors to perform operations comprising:
performing, for each of one or more delivery resources, a first match between a first delivery task and the delivery resource based at least on similarity between the first delivery task and a goods-unpicked delivery task group of the delivery resource;
in response to the first match failing for each of the delivery resources, grouping the first delivery task and one or more unassigned delivery tasks into one or more unassigned delivery task groups; and
performing a second match between the unassigned delivery task groups and the delivery resources based on a preset match rule.

10. The electronic device according to claim 9, wherein the first delivery task belongs to one or more on-time delivery tasks each of which needs to be completed within a predetermined time, and the delivery resources belong to reserved delivery resources for the on-time delivery tasks.

11. The electronic device according to claim 9, wherein the grouping of the first delivery task and the unassigned delivery tasks into the unassigned delivery task groups comprises:
calculating second similarity between the first delivery task and each of the unassigned delivery tasks; and
forming at least one group according to the second similarity.

12. The electronic device according to claim 9, wherein the operations further comprise:
in response to the first match being successful for one of the delivery resources, assigning the first delivery task to the one delivery resource.

13. The electronic device according to claim 9, wherein the operations further comprise:
designating, based on a preset second rule, a second delivery resource to each of one or more of the unassigned delivery task groups for which the second match fails.

14. The electronic device according to claim 10, wherein the operations further comprise at least one of:
in response to determining that a relation between the reserved delivery resources and one or more unassigned on-time delivery tasks satisfies a first preset condition, suspending acceptance of any on-time delivery task request; or
in response to determining that the relation between the reserved delivery resources and the unassigned on-time delivery tasks satisfies a second preset condition, resuming acceptance of an on-time delivery task request.

15. The electronic device according to claim 10, wherein the operations further comprise:
in response to determining that the reserved delivery resources and delivery task completion situation within a preset address range satisfy a third preset condition, determining an on-time delivery task preparation object within the preset address range that satisfies a fourth preset condition, wherein the on-time delivery task preparation object is an object that is capable of receiving an on-time delivery task and preparing goods for the on-time delivery task.

16. The electronic device according to claim 15, wherein the determining of the on-time delivery task preparation object comprises:
in response to determining that goods preparing time of a preparation object within the preset address range is less than or equal to a preset threshold, determining the preparation object as the on-time delivery task preparation object.

17. A computer-readable storage medium having computer instructions stored thereon, wherein the computer instructions are executable by one or more processors to perform operations comprising:
performing, for each of one or more delivery resources, a first match between a first delivery task and the delivery resource based at least on similarity between the first delivery task and a goods-unpicked delivery task group of the delivery resource;
in response to the first match failing for each of the delivery resources, grouping the first delivery task and one or more unassigned delivery tasks into one or more unassigned delivery task groups; and
performing a second match between the unassigned delivery task groups and the delivery resources based on a preset match rule.
